(19) United States
(12) Patent Application Publication
(10) Pub. No.: US 2009/0315200 A1
(43) Pub. Date: Dec. 24, 2009

(54) METHOD FOR MAKING LENS ARRAY

(75) Inventor: TSUNG-YU LIN, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/345,894

(22) Filed: Dec. 30, 2008

(30) Foreign Application Priority Data
Jun. 19, 2008 (CN) 200810302235.0

(51) Int. Cl. B29D 11/00

(52) U.S. Cl. 264/1.36

(57) ABSTRACT

A method for making a lens array, is provided. The method includes: providing a mold core having a plurality of molding surfaces to form the optical surfaces of the lenses; applying a molding material on the mold core; placing a transparent sheet on the molding material and pressing the molding material toward the molding surfaces of the mold core, the transparent sheet having a smooth surface for contacting the molding material; applying a given light beam onto the transparent sheet to solidify the molding material beneath the transparent sheet; and removing the mold core and the transparent sheet to obtain a lens array.

### BACKGROUND

1. Technical Field

The present invention relates to methods for making lens arrays, and particularly, to a light solidifying method for making a lens array.

2. Description of Related Art

Lens arrays includes a plurality of transparent lenses. Each of the lenses usually has a concave or convex microstructure formed on at least one surface thereof. The surfaces having the microstructures are called optical surfaces. In use, a lens array can be used directly, or can be divided into a plurality of lenses.

A typical method for making a lens array, includes: applying a molten molding material on a mold core which has a plurality of molding surfaces formed thereon, then solidifying the molding material by a given light to obtain the lens array. However, air bubbles may occur in the molding material during applying the molding material on the mold core, and remain in the lens array. Furthermore, since the molten molding material is able to flow, a desired contour (e.g. smooth surface) of the lens is difficult to be obtained.

What is needed, therefore, is a method for making a lens array, which can overcome the above shortcomings.

### BRIEF DESCRIPTION OF THE DRAWINGS

Many aspects of the method can be better understood with reference to the following drawings. The components in the drawings are not necessarily drawn to scale, the emphasis instead being placed upon clearly illustrating the principles of the present method. Moreover, in the drawings, like reference numerals designate corresponding parts throughout the several views.

FIG. 1 shows a mold core used in a method in accordance with an embodiment.

FIG. 2 shows the mold core of FIG. 1 is received in a container, and a molding material is applied on the mold core.

FIG. 3 shows a transparent sheet used for pressing the molding material of FIG. 2.

FIG. 4 shows the transparent sheet of FIG. 3 is applied on the molding material.

FIG. 5 shows a given light is applied onto the transparent sheet to solidify the molding material.

FIG. 6 shows a lens array made by the method in accordance with the embodiment.

### DETAILED DESCRIPTION OF THE EMBODIMENTS

Embodiments of the present method will now be described in detail below and with reference to the drawings.

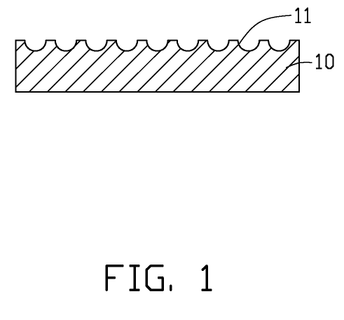

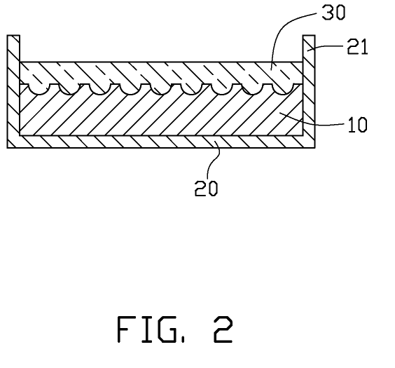

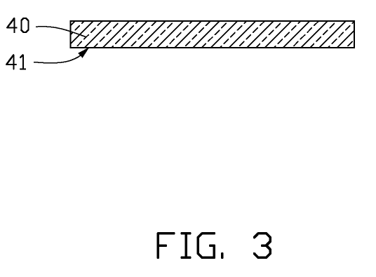

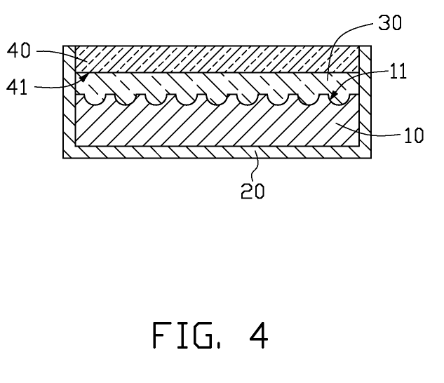

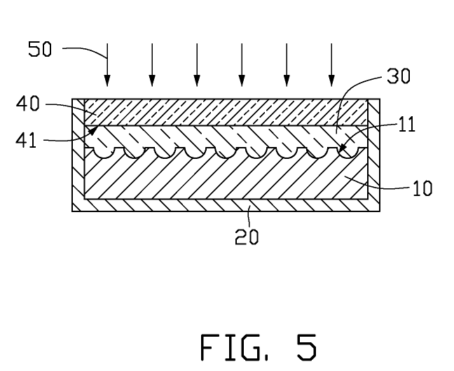

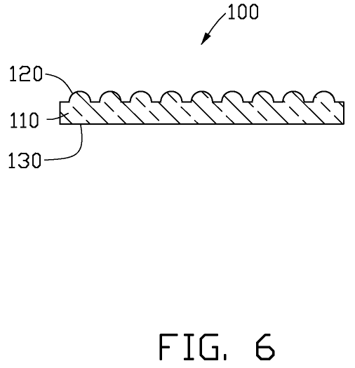

Referring to FIGS. 1 to 6, an exemplary method for making a lens array 100, is provided. The lens array 100 includes a plurality of lenses 110. Each of the lenses 110 has a convex optical surface 120. The method includes:

providing a mold core 10 having a plurality of concave molding surfaces 11 to form the optical surfaces 120 of the lenses 110;

providing a container 20 for receiving the mold core 10 therein, the container 20 providing side walls 21 which are taller than the mold core 10;

applying a molding material 30 on the mold core 10;

placing a transparent sheet 40 on the molding material 30 and pressing the molding material 30 toward the molding surfaces of the mold core, the transparent sheet 40 having a smooth flat surface 41 for contacting the molding material 30;

applying a given light beam 50, for example a UV light beam onto the transparent sheet 40 to solidify the molding material 30 beneath the transparent sheet 40; and

removing the mold core 20 and the transparent sheet 40 to obtain a lens array 100 having a plurality of lenses 110.

The transparent sheet 40 and the mold core 10 are made from polydimethyl siloxane (PDMS). In addition, as the PMMA is easy to depart from the PDMS, the molding material 30 preferably contains polymethylmethacrylate (PMMA). The molding material 30 can be molten or even can be liquid when it is applied on the mold core 10, because the container 20 can well confine such molding material 30. The transparent sheet 40 is also received in the container 20 when it is applied on the molding material 30.

A weight of the transparent sheet 40 is substantially equal to that of the lens array 100. Due to the pressing force of the transparent sheet 40, air bubbles occur in the molding material 30 can die out. The surface of the molding material 30, which is in contact with the transparent sheet 40, can gradually conform the smooth flat surface 41 of the transparent sheet 40, thus a smooth surface 130 of the lens array 100 can be obtained, and the surface 130 can be flat.

Alternatively, if a pressure is applied on the transparent sheet 40, a weight of the transparent sheet 40 can be less than that of the lens array 100.

It is understood that the above-described embodiments are intended to illustrate rather than limit the invention. Variations may be made to the embodiments and methods without departing from the spirit of the invention. Accordingly, it is appropriate that the appended claims be construed broadly and in a manner consistent with the scope of the invention.

What is claimed is:

1. A method for making a lens array, the lens array comprising a plurality of lenses, each of the lenses comprising an optical surface, the method comprising:
providing a mold core having a plurality of molding surfaces to form the optical surfaces of the lenses;
applying a molding material on the mold core;
placing a transparent sheet on the molding material and pressing the molding material toward the molding surfaces of the mold core, the transparent sheet having a smooth surface for contacting the molding material;
applying a given light beam onto the transparent sheet to solidify the molding material beneath the transparent sheet; and
removing the mold core and the transparent sheet to obtain a lens array.

2. The method of claim 1, wherein the smooth surface is a flat surface.

3. The method of claim 1, wherein a weight of the transparent sheet is substantially equal to that of the lens array.

4. The method of claim 1, wherein the mold core and the transparent sheet are both made from polydimethyl siloxane, and the molding material contains polymethylmethacrylate.

5. The method of claim 4, further comprising providing a container, the mold core and the molding material being received in the container, the container being made from polydimethyl siloxane.

6. The method of claim 5, wherein the transparent sheet is received in the container when it is placed on the molding material.

7. The method of claim 5, wherein the molding material is molten when it is applied on the mold core.
